(19) United States
(12) Patent Application Publication
(10) Pub. No.: US 2016/0279577 A1
(43) Pub. Date: Sep. 29, 2016

(54) METHOD FOR THE PRODUCTION OF SOLVENT-STABLE POLYMER MEMBRANES, POLYMER MEMBRANE AND ALSO SOLUTION FOR THE PRODUCTION OF A POLYMER MEMBRANE

(71) Applicant: FRAUNHOFER-GESELLSCHAFT ZUR FÖRDERUNG DER ANGEWANDTEN FORSCHUNG E.V., München (DE)

(72) Inventor: Detlev FRITSCH, Reinbek (DE)

(73) Assignee: FRAUNHOFER-GESELLSCHAFT ZUR FÖRDERUNG DER ANGEWANDTEN FORSCHUNG E.V., München (DE)

(21) Appl. No.: 15/036,586

(22) PCT Filed: Nov. 12, 2014
(86) PCT No.: PCT/EP2014/074308

§ 371 Date: May 13, 2016

(30) Foreign Application Priority Data
Nov. 13, 2013 (DE) 10 2013 223 126.1

(51) Int. Cl. B01D 69/02; B01D 71/60; C08L 33/20; B01D 67/00; B01D 69/08; B01D 71/42; B01D 69/12

(52) U.S. Cl. CPC B01D 69/02; B01D 71/42; B01D 71/60; B01D 69/125; B01D 67/0006; B01D 69/087; B01D 67/0009; B01D 67/0083; C08L 33/20; B01D 2323/08; B01D 2323/12; B01D 2323/30; B01D 2325/04; B01D 2325/02; B01D 2325/20; B01D 2325/30; C08L 2201/56

(57) ABSTRACT

The present invention relates to a method for the production of a solvent-stable polymer membrane, in which a poly(meth)acrylonitrile-comprising solution which comprises, at the same time, a crosslinker, is used. The solution can be poured as a film and the film can be crosslinked. Likewise, it is possible to spin a hollow thread membrane from the solution and subsequently to crosslink this. The thereby produced polymer membrane based on poly(meth)acrylonitrile or copolymers derived herefrom is distinguished by a crosslinking configured throughout. In addition, a solution is described, comprising a solvent and also, dissolved therein, a poly(meth)acrylonitrile or copolymer derived herefrom and also a crosslinker for the polyacrylonitrile which is suitable for the method according to the invention for the production of the polymer membranes according to the invention.

The present invention relates to a method for the production of a solvent-stable polymer membrane, in which a poly(meth)acrylonitrile-comprising solution which comprises, at the same time, a crosslinker, is used. The solution can be poured as a film and the film can be crosslinked. Likewise, it is possible to spin a hollow thread membrane from the solution and subsequently to crosslink this. The thereby produced polymer membrane based on poly(meth)acrylonitrile or copolymers derived herefrom is distinguished by a crosslinking configured throughout. In addition, a solution is described, comprising a solvent and also, dissolved therein, a poly(meth)acrylonitrile or copolymer derived herefrom and also a crosslinker for the polyacrylonitrile which is suitable for the method according to the invention for the production of the polymer membranes according to the invention.

Polymer membranes for substance separation are generally only stable relative to a few organic solvents. Membranes which are produced from polyvinylidene fluoride (PVDF) or from polyacrylonitrile (PAN) have the best stability. However, these membranes are also produced by a phase-inversion process from high-boiling solvents, such as e.g. dimethylformamide (DMF), dimethylsulphoxide (DMSO), dimethylacetamide (DMAC) or N-methylpyrrolidone (NMP), and are of course not stable relative to these solvents.

By means of the phase-inversion process, generally membranes which have an integrally asymmetrical structure are produced. This means, viewed from the upper side (feed side) of the membrane, an increasing porosity towards the underside (permeate side). The actual separation layer of the membrane on the upper side can be adjusted by choice of solvents in principle from pore-free to pores in the micrometre range. Pore-free membranes can be used for gas separation or for nanofiltration, with increasing pore size, membranes for ultrafiltration or microfiltration are obtained. These membranes can be used directly for substance separation.

In the presence of pores of less than 50 nm, however better of less than 25 nm, the membranes are suitable in addition also as underlayer (carrier membrane) of composite membranes. The requirements for gas-or liquid separation are different here. For use in gas separation, a flow of at least 10 times greater of the end flow of the composite membranes is required. Generally, gas flows greater than 100 m³/m²hbar are required here. For liquid applications, such as ultra- or nanofiltration, generally water flows of >50 l/m²hbar are sufficient. In principle, higher flows with small and average pore sizes imply higher porosity and should be striven for.

Composite membranes consist of a porous carrier membrane on which the actual separation layer is applied by known methods, such as spraying, printing, roller application, nozzle coating or injection- or immersion methods. This separation layer generally consists of a second polymer which delivers the selectivity. In order to achieve sufficient throughput for commercial application, this separation layer must be applied as thinly and defect-free as possible and must adhere well. The typical thickness, according to use and material, is between 50 and 1,000 nm. This separation layer can be made solvent-stable, in addition, by suitable methods, such as e.g. crosslinking techniques. When applying a solvent-stable separation layer on a solvent-stable carrier membrane, the obtained membranes per se are solvent-stable.

Solvent- and acid-stable polymer membranes are described in the patent literature. Thus, in EP 0574957 (1990), a PAN membrane is treated basically with sodium ethanolate and is consequently crosslinked. The membrane thereby changes colour, becomes dark brown and brittle. The cut-off is typically at 5,000 g/mol. This membrane is not usable as carrier for composite membranes.

In WO 2010/082194 (2010), commercial membranes made of various polymers, such as polysulphone (PS), polyether sulphone (PES), PAN, PVDF, are crosslinked with polyethylene imine (PEI). In addition, PES membranes are chlorosulphonated and can then be crosslinked with PEI. In the case of PS membranes, the pores protected from collapsing with glycerine must be cleaned in a pretreatment in order then to be pretreated with high-molecular PEI and to be crosslinked with an at least bi-functional crosslinker. PAN- and PVDF membranes are saturated with an aqueous solution of low- and high-molecular PEI and heat-treated for 15 -20 h at 90° C. and washed. The obtained membranes are acid- and solvent-stable and display high permeate flows. Furthermore, some of the membranes display an approx. 99% retention of Cu²⁺ ions from water and a glucose retention of 98-99% from the high-boiling solvents NMP and DMF. It is not reported whether the membrane pores must be protected from collapsing by glycerine or the like and whether composite membranes can be produced from these carrier membranes. Production based on commercially available membranes is tedious and requires 90° C. over a period of time of up to 20 h. WO 2010/082194 describes a crosslinked, semi-permeable membrane made of polymers with reactive groups which are crosslinked on the surface with suitable reactants, a further polymer or oligomer. As reactive groups, -Cn and Cl (in general halogen) are mentioned in particular. As further polymers for the crosslinking, polyethylene imines (PEI) and polyvinyl alcohol are listed. Before the crosslinking on the surface, porous membranes, e.g. made of PAN, PVDF, etc., are produced in a first method step, which membranes are crosslinked, in a subsequent step, with the polymer suitable for crosslinking on the surface and hence are stabilised relative to solvents.

The membranes can also be operated in N-methylpyrrolidone (NMP), a solvent for PAN. Since the crosslinking takes place only on the surface of the previously produced membrane, there are, in the interior, non-accessible part of the membrane, non-crosslinked regions which swell greatly, or polymer can also be dissolved therefrom diffusively and the membrane loses stability or is destroyed.

In DE19811997 (1998), a PAN copolymer made of acrylonitrile and glycidyl methacrylate is produced. The glycidyl groups are crosslinked by ammonia at 120° C. in an autoclave and a solvent-stable membrane is obtained. This membrane is very well suited for binding enzymes in the membrane before the crosslinking, however it is not pressure-stable for pressures of up to 60 bar and not suitable for composite membranes.

In DE19811998 (1998), PAN copolymers, which can be crosslinked via functional groups, are synthesised and are crosslinked, after the membrane production in a second step, with di- to polyfunctional reagents. DE19811997 and DE19811998 have the disadvantage that special comonomers must be produced and, for crosslinking, bases or acids must be added, the excesses of which are removed by washing in a further step.

In WO 2007/1125367, nanoporous membranes are produced from polyimides, which membranes display a cut-off value below 500 g/mol and are suitable in principle as carrier material for composite membranes. However, the pores of these membranes must be protected from collapsing. For this purpose, the membranes are impregnated with hygroscopic substances, such as glycerine or low-molecular polyethylene glycols. In general, this prevents use as carrier material for composite membranes since this treatment prevents coating. Furthermore, the membranes, in order to be stable relative to solvents, must be crosslinked in a second step with suitable di- or polyamines. Furthermore, these membranes have no stability in basic pH values>pH=9 since the polyimide structure is attacked and the membranes are destroyed.

Polyacrylonitrile is a polymer which can be used readily for polymer membranes, which polymer has good solvent stability and can be processed, nevertheless, from some high-boiling solvents by the phase-inversion process to form fibres or membranes. Frequently used solvents for PAN are e.g. dimethylacetamide (DMAC), dimethylformamide (DMF), ethylene carbonate, γ-butyrolactone (GBL), N-methylpyrrolidone (NMP). For commercial fibre spinning processes, also aqueous solutions of salts, such as sodium thiocyanate (NaSCN) and zinc chloride or nitric acid, are used. Dimethylsulphoxide (DMSO) is used in fibre spinning only to a lesser extent [see A. Nogaj, C. Süling, M. Schweizer, Fibers, 8. Polyacrylonitrile Fibers, in: Ullmann's Encyclopedia of Industrial Chemistry, Wiley-VCH Verlag GmbH & Co. KGaA, 2000].

Porous membranes produced from solvent by phase-inversion process are distinguished by a large outer and inner surface. This surface was used for crosslinking reactions in order to stabilise the membrane relative to solvents [WO 2010/082194]. The polyethylene imine used for this purpose in the case of PAN is applied from aqueous or aqueous/alcoholic solution, penetrates into the pores and leads to crosslinking on the outer and inner membrane surface. For this purpose, the membrane is however treated for 17 h and 90° C. in a closed reactor and thereafter washed and dried. These membranes are stable relative to high-boilers, such as NMP. If the membranes are treated according to this method only at RT for 17 h, the membranes are not crosslinked and are destroyed by high-boilers, such as NMP, DMF, DMAC, etc.

The methods used in the literature for the production of PAN membranes are mostly based on the solvents DMF and NMP. More rarely DMAC or DMSO is used. The membrane to be produced should have as extensive a foam structure as possible in order to ensure high pressure stability. Pressures up to 80 bar are common in reverse osmosis and can also be required in nanofiltration with organic solvents for an economical process.

According to the known methods, a mixture of solvent and swelling means or non-solvent is used for the membrane production. DMSO was selected here as base solvent since it should be regarded, according to the REACH specifications, as the best choice compared with DMF, NMP and DMAC or sulpholane.

In DE69831305, hollow threads are produced from PAN for the filtration and have a complete foam structure. For this purpose, the solvent propylene carbonate is added to the solvent DMSO and mixed with polyethylene glycol of a low molar mass as non-solvent in order to keep close to the precipitation limit. The polymer concentration was >18% and a high-molecular PAN was used. A very high viscosity was produced therefrom with which hollow threads can be produced. For flat membranes, a pourable solution is generally required. Propylene carbonate is an important component of the pouring solution in DE 69831305. Without this substance, it is described as difficult to obtain a membrane with the desired properties. This composition of the pouring solution is not usable for flat membranes because of the high viscosity. Furthermore, for pouring solutions which comprise the crosslinker PEI, no solvents or solvent additives which react with PEI and consequently make the crosslinker ineffective can be used. There are included herein propylene carbonate, ethylene carbonate and gamma-butyrolactone. Other swelling means or non-solvents must therefore be found. Membranes produced without the addition of swelling means or non-solvents and made from the pure solvents DMF, DMAC or DMSO in fact produce membranes with the crosslinking additive PEI. However these have very large caverns which appear as far as just below the separation layer. Hence the danger of defects is greatly increased and the entire membrane is not suitable for use at high pressure.

Therefore additives must be found which act as swelling means or non-solvents which bring the polymer solutions close to the precipitation limit and do not react with PEI. Furthermore, these substances should display a high to complete water miscibility, be non-toxic and easily biodegradable.

Starting herefrom, it is hence the object of the present invention to describe a method for the production of a polymer membrane based on acrylonitriles, with which solvent-stable membranes which have as homogeneous a property profile as possible are producible in a simple manner.

The membranes to be developed here are intended to be mechanically stable, flexible, highly-porous, solvent-stable and coatable with further polymers to form composite membranes, hence do not have the above-described disadvantages. Furthermore, the membrane according to the invention is intended to be produced from a pouring solution, in one method step, and to be manufactured by further normal method steps, known to the person skilled in the art, such as washing and drying of the membrane. No impregnation means in order to protect the pores of the membrane from collapsing should be required. Both in the wet state and the dry state, the membrane is intended to be coatable without defects by means of normal methods. In addition, this membrane is intended in general to be useable for filtration from water and organic solvents.

The object of the invention hence resides in producing a porous membrane which is resistant to high- and low-boiling solvents and which do not vary in their separation properties. The individual method steps should thereby be implementable with low complexity and on conventional membrane-producing machines. The membrane according to the invention is intended to be suitable both for filtration, in general, and as substrate for composite membranes. In the choice of solvents for the phase-inversion process, only solvents which are classified as unproblematic, according to the European Chemical Regulation REACH, should be used.

This object is achieved according to the method for the production of a solvent-stable polymer membrane by the features of patent claim 1, with respect to a polymer membrane, by the features of claim 6 and also with a solution for the production of a polymer membrane, by the features of patent claim 12. The respectively dependent patent claims thereby represent advantageous developments.

According to the invention, a method for the production of a solvent-stable polymer membrane is hence described, in which a solution, comprising or consisting of
a) poly(meth)acrylonitrile, a copolymer based on (meth)acrylonitrile or mixtures hereof,
b) at least one crosslinker for poly(meth)acrylonitrile or a copolymer based on (meth)acrylonitrile, and also
c) at least one solvent for poly(meth)acrylonitrile or a copolymer based on (meth)acrylonitrile in which the previously mentioned components are present in dissolved state
   is poured as a film or spun to form a hollow thread, the poly(meth)acrylonitrile, copolymer based on (meth)acrylonitrile or mixture hereof is precipitated by a phase-inversion process and the poly(meth)acrylonitrile, copolymer based on (meth)acrylonitrile or mixture hereof is crosslinked by temperature treatment at temperatures increased relative to room temperature.

Surprisingly, it was found that the crosslinker can even be added to the pouring or spinning solution before the membrane production and the solution is usable, possibly after the normal treatment such as filtration and degassing, for the membrane production. The crosslinker, such as e.g. the very readily water-soluble crosslinker PEI, is not washed out or only in part even during the precipitation process, e.g. in water, and can crosslink the PAN membrane in the interior by subsequent temperature treatment via the reactive cyano groups. As a result, solvent-stable membranes are available in a continuous production process.

The term poly(meth)acrylonitrile thereby stands for polyacrylonitriles which can be substituted by a methyl group, possibly on the vinyl group, and hence comprises both polyacrylonitrile and poly(meth)acrylonitrile. Copolymers based on (meth)acrylonitrile are thereby derived essentially from the monomeric (meth)acrylonitrile, i.e. preferably these polymers are derived from (meth)acrylonitrile to at least 80% by mol. Polyacrylonitrile is thereby particularly preferred.

Precipitation of the poly(meth)acrylonitrile by a phase-inversion process is thereby already known in the literature and is implemented also according to the present invention, as described in the state of the art. In particular water or suitable aqueous solutions thereby represent suitable precipitation baths. In the case where aqueous solutions are used, it is preferred if solvents which are not water-toxic are used. The advantage thereby is that the solution of the precipitation bath, during the exchange, can be introduced directly into the discharge channels without further treatment for biological purification. The process of phase inversion is known in particular from DE198 11 998 C1, reference is made to this publication with respect to the details for implementing the phase-inversion process. Preferably, the precipitation bath has temperatures which are at room temperature±20° C., preferably room temperature±10° C.

In the case where a flat membrane is produced, the solution is poured as a film. In the case where a hollow thread membrane is produced, the solution is spun through an annular nozzle. In principle, it is hereby conceivable that air-spinning is effected, i.e. that, before introduction into the precipitation bath, the produced hollow thread, which is produced by the annular nozzle, is transported in the direction of the precipitation bath via an air gap, it is likewise possible that direct spinning of the hollow thread into the spinning solution itself is effected. In the case of production of a hollow thread by spinning the solution according to the invention, it is likewise possible that the hollow thread is introduced already into a hot precipitation bath, the precipitation bath can hereby have for example temperatures of 80 to 99° C., preferably 90 to 97° C., in particular approx. 95° C. In fact upon entry of the hollow thread into the precipitation bath, simultaneous precipitation and crosslinking of the polymer membrane hereby takes place.

The crosslinking is achieved by temperature treatment of the obtained film or hollow thread, it is thereby achieved, according to the invention, that a completely homogeneously configured film or hollow threads is achieved.

Preferably, the pouring or the spinning and the precipitation of the film is effected at temperatures at which the crosslinking is not yet activated or takes place.

The disadvantages according to membranes known from the state of the art can thereby be avoided, in the case of which merely crosslinking on the surface of corresponding membranes is implemented (see for example WO 2010/082194 A2). Hence an extremely high crosslinking of the poly(meth)acrylonitrile or of the copolymer hereof which is used is achieved according to the invention, with which the solvent resistance of the polymer membranes, according to the invention, exceeds that of membranes known from the state of the art.

In the case where a flat membrane is intended to be produced, it is preferred if the film is poured onto a substrate. In particular onto a nonwoven made of a polymeric material, preferably polyester. This embodiment is advantageous in particular since, on the one hand, a continuous transport of the polymer membrane applied on the flow material through the precipitation bath or through a further bath is possible, on the other hand, a finished composite membrane can be produced in one step.

Furthermore, the film or hollow thread obtained after the phase-inversion process can be washed with water.

The temperature treatment used for the crosslinking is thereby implemented advantageously at temperatures of 50 to 150° C., preferably of 70 to 120° C., particularly preferably of 85 to 99° C.

It is thereby implemented, particularly preferably and according to the invention, directly following the precipitation step and/or the possibly effected washing step and also the temperature treatment. According to a particularly preferred embodiment of the present invention, a water bath is used for this purpose, which water bath has a temperature of more than 50° C., preferably 50 to 99° C., further preferably 70 to 99° C., in particular 85 to 95° C. For example, it is possible that the continuously produced films or hollow fibres are discharged from the precipitation bath and introduced into a temperature-controlled water bath. This can be effected for example by means of machines for membrane production which are suitable and known from the state of the art for this purpose. Alternatively, it is likewise possible to implement the method continuously. The steps of precipitation, crosslinking/washing, drying can be effected in a machine and a dry membrane according to the invention is obtained. It can also be provided for example that the produced films or hollow threads are firstly removed from the precipitation bath and rolled onto a corresponding storage roller and the roller itself is temperature-controlled, for example in a water bath. It is particularly advantageous during implementation of the temperature-controlling step in the water bath that possibly any solvent still present in the produced polymer membrane is thereby completely washed out.

The temperature treatment is thereby implemented advantageously over a period of time of 5 min to 24 hours, preferably 15 min to 12 hours, particularly preferably of 20 min to 60 min.

Possibly, after crosslinking and/or the washing step, drying of the membrane can be implemented, preferably in an air flow at a temperature between 60 and 120° C. Preferably the crosslinking step is in fact implemented such that a completely crosslinked membrane is present so that, during the drying step, no further crosslinking and, as a result thereof, no dimensional change in the produced membrane takes place. Merely any still adhering water or possibly present solvent are hence removed during the drying step.

In principle, it is however likewise conceivable that the crosslinking step is implemented during the drying step, preferably as described above.

In addition, the present invention relates to a polymer membrane made of poly(meth)acrylonitrile or copolymers derived herefrom which are distinguished by a crosslinking, configured throughout, of the poly(meth)acrylonitrile or of the copolymer hereof. The crosslinking is hence configured not only on the surface of the membrane, but uniformly through the entire membrane.

The membrane can thereby be configured in principle as a film, likewise it is conceivable that the membrane has the form of a hollow thread.

Preferably, the thickness of the membrane, without any possibly present substrate, is of 20 to 200 μm, preferably of 40 to 90 μm.

The thickness of the membrane thereby refers either to the layer thickness of the film or to the thickness of the wall of the hollow thread.

In the case where a further substrate is present, this is preferably a nonwoven, in particular a polyester nonwoven.

The presence of a substrate, for example a nonwoven, in particular a polyester nonwoven, is thereby preferred in particular in the case of film membranes.

Preferably, the membrane has pores, the pore size at the bubble point being at 20 to 100 nm, particularly preferably at 30 to 50 nm. The bubble point of the membranes is in the range of 6 to 20 bar, preferably 15 to 20 bar, corresponding to a pore size at the bubble point of 43 to 32 nm. For determination of the bubble point, a porometer (Porolux®500) was used. The bubble point is indicated in the case of the first measurable flow and corresponds to the largest pore, the pore at the bubble point. The average pore size is determined as the pore size in the case of 50% of the total flow. The bubble point represents a measure of the quality of the obtained membrane in conjunction with the average pore size. For example, an average pore size of 30 nm at the bubble point, in the case of an average pore size of 20 nm, represents a very good membrane. A pore size at the bubble point of 150 nm, in the case of an average pore size of 20 nm, represents a rather poor membrane. Alternatively hereto, the pore size always corresponds to a pressure which is applied to the membrane for measurement. In this respect, it is likewise possible to define the pore size directly via the bubble point as a function of a pressure. A preferred pore size can hence be defined via the bubble point test. The pressure is hereby preferably >6 bar (which corresponds to a pore size of approx. 100 nm), preferably greater than 10 bar (which corresponds to a pore size of approx. 60 nm) or particularly preferably >20 bar (which corresponds to a pore size <32 nm).

The bubble point describes the largest pore and hence a measure of defects in the membrane. The quality of the membrane has hence two characteristic values:
1) the bubble point
2) average pore size

According to the first criterion, in fact defects are measured, according to the second criterion, the actual porosity of the membrane. The throughflow of the membrane for gases at the bubble point is typically <0.01% of the flow in the case of the average pore size.

Preferred average or mean pore sizes of the membrane according to the invention are thereby of 15 to 30 nm, preferably of 18 to 25 nm.

The pores are thereby produced independently in the precipitation step or in a subsequent washing step and fixed by the crosslinking step.

The nitrogen permeability JN2 of the polymer membrane according to the invention is thereby preferably 10 to 1,000 m³/(m²·h·bar). Determination of the nitrogen permeability is effected with a gas burette. The gas flow is thereby measured per unit of time and related to the surface area and the pressure. Alternatively, the use of a gas measuring device, e.g. Definer 220 by BIOS, is likewise suitable for determining the gas flow. Likewise, it is possible to determine the measurement of the gas flow at 3 bar, with a porometer (e.g. Porolux®500).

The pores are thereby disposed in a foam structure, preferably asymmetrically from the upper side to the underside of the membrane with increasing pore size. The membrane can also have caverns in the lower region. The foam structure is configured at least with a thickness of 2 μm. Advantageously, the foam structure is 10-40 μm up to caverns or the membrane is free of caverns. The membrane structure is examined with scanning electron micrographs.

In addition, the invention relates to a solution for the production of a polymer membrane, comprising or consisting of
a) poly(meth)acrylonitrile, a copolymer based on (meth)acrylonitrile or mixtures hereof,
b) at least one crosslinker for poly(meth)acrylonitrile or a copolymer based on (meth)acrylonitrile, and also
   at least one solvent for poly(meth)acrylonitrile or a copolymer based on (meth)acrylonitrile, in which the previously mentioned components are present in dissolved state.

Suitable solvents are thereby selected from the group consisting of dimethylsulphoxide (DMSO), dimethylformamide (DMF), N-methylpyrrolidone (NMP), dimethylacetamide (DMAC), tetrahydrothiophene-1,1-dioxide (sulpholane), aqueous solutions of sodium thiocyanate and/or zinc chloride and also mixtures hereof.

According to the invention, dimethylsulphoxide (DMSO) is particularly preferred as solvent.

The crosslinker is thereby preferably an amino group-containing polymer which is selected preferably from the group consisting of polyethylene imine (PEI), polyvinyl amine, polyallyl amine and/or mixtures or combinations hereof, the polyethylene imine (PEI), polyvinyl amine or polyallyl amine preferably having a number-average molecular weight Mw of 25,000 to 750,000 g/mol.

Likewise, it is possible that the crosslinker is added to the solution in the form of a precursor compound, the crosslinker being released in situ from the precursor compound during the method management according to the invention. The precursor compounds are thereby for example blocked polyethylene imine, blocked polyvinyl amine, blocked polyallyl amine and/or mixtures or combinations hereof, the blocked polyethylene imine (PEI), blocked polyvinyl amine or blocked polyallyl amine preferably having a number-average molecular weight Mw of 25,000 to 750,000 g/mol. In the sense according to the invention, “blocked” thereby means that the respective crosslinking-active functionalities of the previously mentioned amines are inactive, i.e. are chemically masked. This can be achieved for example by the corresponding amines being converted with ketones to form corresponding ketimines, preferably aliphatic ketones, in particular methyl isobutyl ketone being used. Particularly preferred precursor compounds are hence the ketimine of polyethylene imine, the ketimine of polyvinyl amine and the ketimine of polyallyl amine, the keto group being derived preferably from aliphatic ketones, in particular from methyl-iso-butylketone. In the case of the production method according to the invention, release of the crosslinker could be observed under the influence of temperature and/or moisture.

A further preferred embodiment of the solution according to the invention provides that it comprises a non-solvent in which poly(meth)acrylonitrile or the copolymer derived herefrom do not dissolve. The non-solvent must however be miscible with the solvent and the precipitant (water). The use of the non-solvent leads to an increase in the solvent viscosity of the solution used. This has a particularly advantageous effect on the produced membrane since, in the case of deposition from such a solution, smaller pore sizes are achievable. The consequently produced membrane consequently has a foam-like structure.

Preferably, the non-solvent is selected from the group consisting of 1,3-dioxolane, polyalkylene glycol, in particular polyethylene glycol, tetraalkylene glycol, in particular tetraethylene glycol, alcohols, in particular ispropanol, ethanol, alkyl lactates, in particular ethyl lactate and also mixtures hereof.

Further advantageously, the total content of poly(meth)acrylonitrile, of the copolymer based on (meth)acrylonitrile or mixtures hereof, relative to the solvent and also possibly the sum of solvent and non-solvent, is from 1 to 30% by weight, preferably 5 to 20% by weight, particularly preferably 7.5 to 15% by weight.

Preferably, the total content of the crosslinker, relative to poly(meth)acrylonitrile, the copolymer based on (meth)acrylonitrile or mixtures hereof, is from 1 to 50% by weight, preferably 3 to 20% by weight, particularly preferably 8 to 14% by weight.

The content of the non-solvent, relative to the content of the solvent or of the mixture of at least two solvents, is thereby preferably 50 to 60% by weight, preferably 15 to 45% by weight.

According to a particularly preferred embodiment, the polymer used is polyacrylonitrile. Preferred copolymers are obtainable by copolymerisation of (meth)acrylonitrile with at least one copolymer, selected from the group consisting of (meth)allyl sulphonic acid or the salts thereof.

The solution thereby has a preferred viscosity of 1.5 to 20 Pa·s, preferably 4 to 12 Pa·s.

The present invention is described in more detail with reference to the subsequent embodiments, Figures and also examples without restricting the invention to the illustrated special parameters.

There are thereby shown

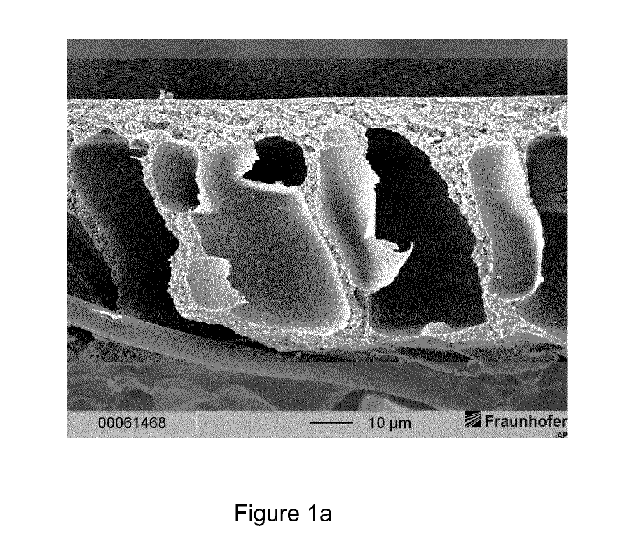

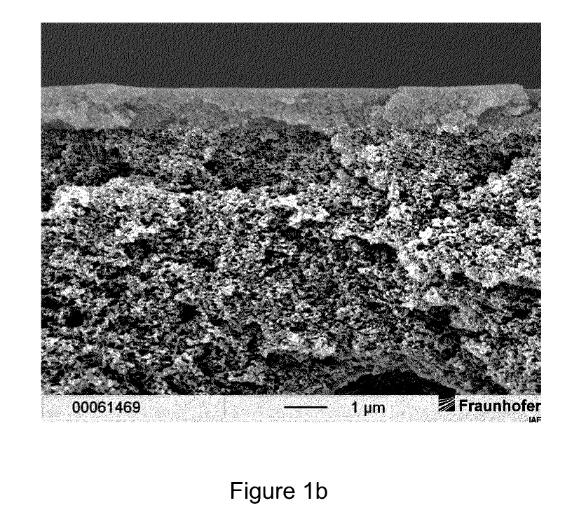

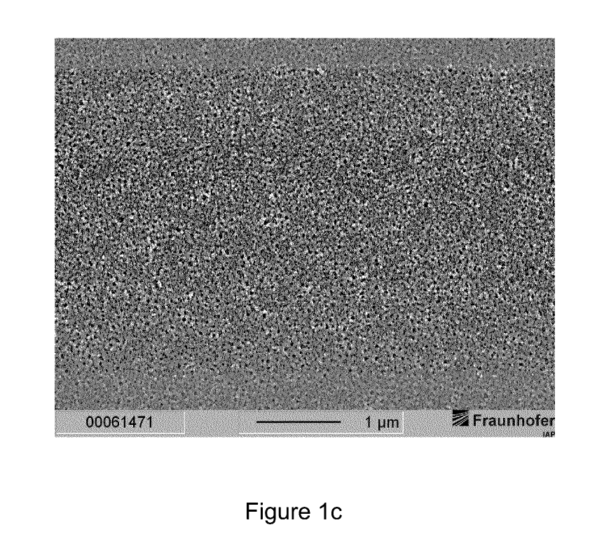

FIG. 1a a scanning electron micrograph of a cross-section of a polyacrylonitrile flat membrane according to the invention

FIG. 1b an enlarged detail of the polyacrylonitrile flat membrane illustrated in FIG. 1a

FIG. 1c a scanning electron micrograph of the surface of the polyacrylonitrile flat membrane illustrated in FIGS. 1a and 1b

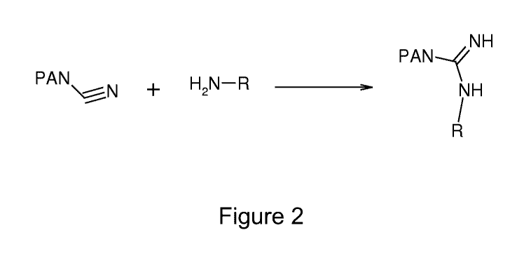

FIG. 2 the reaction principle of the crosslinking membrane of polyacrylonitrile

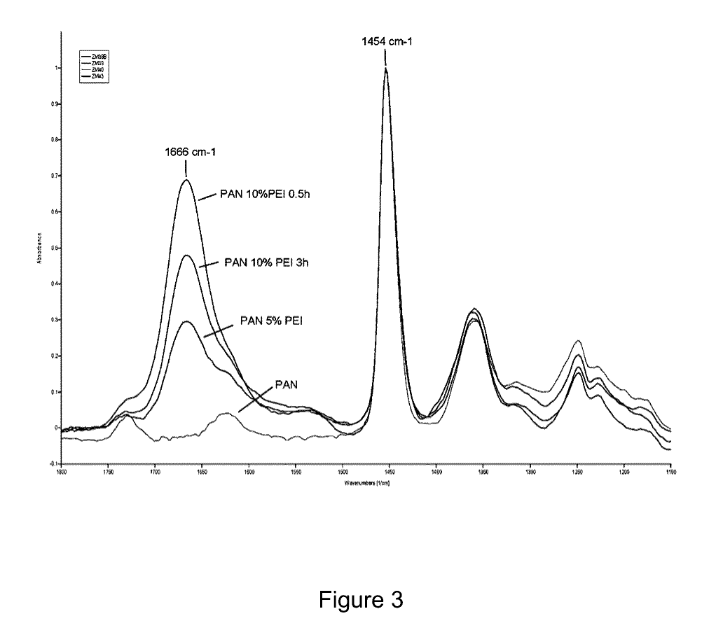

FIG. 3 an FTIR image of a membrane produced according to the invention

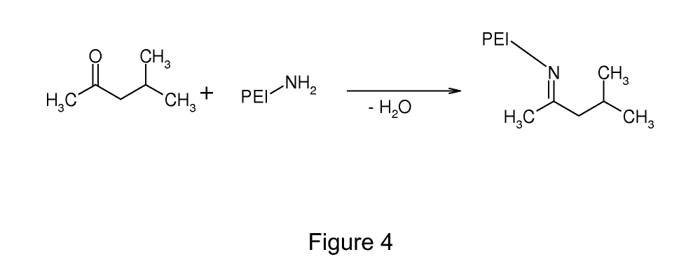

FIG. 4 the reaction principle of the ketimine formation

### SUBSTANCES AND METHODS USED

PAN-1: acrylonitrile (93.5%) methacrylate (6%) sodium methallyl sulphonate (0.5%) copolymer.
   Inherent viscosity (DMF) 140 cm³/g.
PAN-2: polyacrylonitrile homopolymer (max. 0.5% methylacrylate).
   Inherent viscosity (DMF) 194 cm³/g.

Polyethylene Imines:

Lupasol G20=PEI-G20 (Mw=1,300 g/mol))

Lupasol WF=PEI-WF (Mw=25,000 g/mol)

Lupasol P=PEI-P (Mw=750,000 g/mol)

PEG: polyethylene glycol 200

TEG: tetraethylene glycol

MIBK: methyl isobutyl ketone

Viscosity:

For the pouring solutions, the viscosity is measured with a rotational viscosimeter DIN/ISO viscosimeter 550 (of Thermo Haake). The value at a speed of rotation of 100 rpm is indicated in Pa*s.

SEM: scanning electron micrograph. Breakage in liquid nitrogen or surface, both sputtered with Au.

Porometer: a porometer Porolux® 500 was used. The bubble point is indicated in the case of the first measurable flow and corresponds to the largest pore. The average pore size is the pore size at 50% of the total flow.

% data: the percentage data are masses.

A polyester nonwoven (PET) was used with a basis weight of approx. 100 g/m² and a thickness of 160 μm.

In order to obtain crosslinked membranes, a crosslinker, e.g. PEI, is added to the pouring solution according to the invention. Pouring solutions, which comprise ketones such as acetone or diacetone alcohol, cannot be mixed with PEI since these can be converted with PEI into imines or enamines. Preferably, the crosslinker PEI can therefore be added to pouring solutions with 1,3-dioxolane, TEG or PEG in order to obtain the reactivity for the crosslinking with the cyano groups.

By the addition of PEI to the pouring solution, the crosslinker is added before the membrane production and a crosslinked, solvent-stable membrane is obtained according to the normal method steps. The crosslinking reaction only occurs at increased temperature. This means that the polymer is added firstly without crosslinker, possibly dissolved at increased temperature, and the crosslinker at RT. It is hereby advantageous to operate under protective gas in order to avoid subsidiary reactions.

The crosslinking reaction can be effected after the precipitation and the possibly effected washing of the membrane at temperatures of typically 120-150° C., solvent-stable, open membranes being obtained. The crosslinking is implemented preferably in water at temperatures of 60-100° C. Temperatures of 90-95° C. are hereby advantageous. Adequate crosslinking takes places already after 20-60 min at these temperatures.

Normally, 30 min at 95° C. is sufficient. Further crosslinking can be effected at increased temperature in the drying cabinet after hot-washing.

### EXAMPLE1

### Membrane Made of DMSO with 10% PEI

A 13% solution of PAN-1 in DMSO is prepared which, relative to PAN-1, comprises 10% PEI-WF. PEI-WF is added to the pouring solution only after the solution of PAN-1 and thereafter is no longer heated above RT. The viscosity was 2.7 Pa*s. Only solvents and PEI with water contents of less than 0.1% are used.

On a membrane-drawing machine, a membrane is produced on a polyester nonwoven with a doctor blade with a gap of 250 μm at 2 m/min. It is precipitated in water of 20° C., washed at 45° C. for 16 h and dried for 2 h at 105° C. The membrane is thereby discoloured towards yellow, becomes somewhat more rigid but remains flexible without breaking with bending stress. In the scanning electron micrograph, large caverns can be seen. The top layer of the membrane has a thickness of 0.5 μm with a total thickness (without PET nonwoven) of approx. 90 μm. The gas flow of the porous membrane is at approx. 10 m³/[m²*h*bar].

### EXAMPLE 2

### Membrane Made of DMSO/IPA(9/1) with 10% PEI

In order to bring the pouring solution closer to the precipitation limit, the non-solvent isopropanol was added to the pouring solution. The structure of the membrane did not change although the gap of the doctor blade was adjusted to 200 and 250 μm. In the scanning electron micrographs, large caverns can be seen, which end in an approx. 0.5 μm thick top layer on the membrane upper side (see example 2).

15 g PAN-1 is dissolved in a mixture of 88.5g DMSO with 9.8 g isopropanol at 60° C. under N2 protective gas. At RT, it is mixed with 1.7 g PEI-WF and agitated further under protective gas for 24 h. It was left to stand for 16 h under protective gas and drawn as membranes according to example 1. The viscosity of the solution was 6.2 Pa*s. The doctor blade gap was adjusted to 250 μm and 200 μm and the drawing rate was reduced to 0.6 m/min. The precipitation bath temperature was 18° C., the washing time at 45° C. for 16 h. The membranes were dried for 2 h at 105° C. The gas flow of the membranes was approx. 5 m³/[m²*h*bar] (gap 250 μm) and approx. 8 m³/[m²*h*bar] (gap 200 μm). The total thickness of the membranes was, without PET nonwoven, at 42 μm (250 μm gap) and 35 μm (200 μm gap).

### EXAMPLE 3

### Membranes Made of DMSO, Crosslinked with PEI, with 1.3-Dioxolane and/or TEG, PEG as Non-Solvent

In example 3, seven pouring solutions 1 to 7 according to the invention are described in table 5, which pouring solutions all lead to solvent-stable membranes after temperature treatment. The content of crosslinker PEI can be between 3 and 20%. Membranes were produced from the pouring solutions on a membrane-drawing machine, as in example 1. The production conditions and the properties are described in table 2.

The pouring solutions were produced from PAN-1 (PS 1, 2) or PAN-2 (PS 3-7). DMSO-1,3-dioxolane or DMSO-DMF-1,3-dioxolane mixtures were used as solvents. In the indicated concentrations, readily pourable polymer solutions were obtained with the crosslinker PEI. PEI-WF (PS 1-3) and PEI-P (PS 3-7) was used as crosslinker. Crosslinking with the high-molecular PEI-P is particularly successful. The pouring solutions were prepared, as described in example 2 and membranes were produced therefrom, as in example 1. The drawing parameters, the N₂ flow and the structure according to scanning electron micrographs are compiled in table 2. In order to obtain a foam structure throughout, also TEG or PEG can be added to the pouring solutions. The polymer concentration should not be substantially below 14% (PAN-1) or 10% (PEI-2).

TABLE 1

| | Concen- | Content PEI | | Ratio | Dynamic |
|---|---|---|---|---|---|
| PS | tration | relative to | Solvent | solvent | viscos- |
| No. | PAN, % | PAN, % | mixture | w/w | ity, Pa*s |
| 1 | 14 | 9.3 | DMSO/DMF/1,3- | 4/4/2 | 2.6 |
| | | | dioxolane | | |
| 2 | 14 | 19 | DMSO/1,3- | 8/2 | 3.8 |
| | | | dioxolane | | |
| 3 | 9.5 | 10 | DMSO/DMF/1,3- | 4/4/2 | nd |
| | | | dioxolane | | |
| 4 | 9.9 | 10 | DMSO/1,3- | 6/4 | nd |
| | | | dioxolane | | |
| 5 | 9.9 | 10 | DMSO/1,3- | 6/4 | 13.2 |
| | | | dioxolane | | |
| 6 | 9.9 | 5.5 | DMSO/1,3- | 6/4 | 9.1 |
| | | | dioxolane | | |
| 7 | 9.9 | 3 | DMSO/1,3- | 6/4 | 5.2 |
| | | | dioxolane | | |

PS 1, 2 made of PAN-1 with PEI-WF; PS 3 PEI-2 with PEI-WF; PS 3-7 PEI-2 with PEI-P

TABLE 2

| | | | Drawing | JN2, | Spacing | Membrane, |
|---|---|---|---|---|---|---|
| PS | Mem- | Gap, | rate, | m³/ | cavern, | thickness, |
| No. | brane | μm | m/min | [m²*h*bar] | μm | μm |
| 1 | A | 225 | 2 | 21 | <0.5 | 55 |
| 2 | B | 225 | 2 | 180 | <0.5 | 40 |
| 3 | C | 225 | 1 | 200 | nd | nd |
| 3 | D | 225 | 1 | 140 | nd | nd |
| 4 | E2 | 225 | 1 | 300 | 9 | 62 |
| 5 | F | 225 | 1 | 430 | 6 | 79 |
| 6 | G | 200 | 1 | 520 | 9 | 60 |
| 7 | H | 200 | 1 | 480 | 9 | 35 |
| 7 | I | 200 | 1 | 640 | 6 | 70 |

Membranes A, B from table 2 have very large caverns at only a few hundred nanometres of top layer thickness. These membranes were washed for 3 h in water of 22° C. and dried thereafter for 2 h at 105° C.

The colour change was effected, as described in example 1, towards yellow during the temperature treatment in the drying cabinet. Membranes C, D (table 2) were produced from the same pouring solution but treated differently. Membrane D was dried after the washing (3 h, 22° C.) for 2 h at 105° C., the comparative membrane C was subjected to a solvent exchange. The water in the pores was replaced thereby in three steps by isopropanol and exchanged for n-heptane in three further steps. After air-drying, the membrane was crosslinked for 2 h at 105° C. in the drying cabinet. The N₂ flow rose from 140 m³/[m²*h*bar] (membrane D) to 200 m³/[m²*h*bar] during solvent exchange (membrane C). Membranes made of pouring solution 4 (membrane E) were treated further after the drawing according to three methods.

Test E was implemented in three different methods, which led to the individual different membranes E1, E2 and E3.

Membrane E1 (not listed in table 2) was washed for 3 h at 23° C. and dried directly for 2 h at 120° C. Membrane E2, after washing for 3 h at 23° C., was washed further for 0.5 h in water at 95° C. and thereafter dried immediately at 120° C. for 2 h. During the soaking at 95° C., crosslinking occurred, visible by discolouration of the membrane towards yellow. This colour deepened after the temperature treatment in the drying cabinet. Membrane E3 (not listed in table 2) was washed for 3 h at 40° C. and thereafter dried directly at 120° C. for 2 h. By comparison, all three treatment methods led to crosslinked membranes. However, E1 and E3 showed a rough surface with very large pores. Only membrane E2, which was crosslinked in water for 0.5 h at 95° C., with subsequent crosslinking in the drying cabinet at 120° C., displayed a smooth, glossy surface with adequate thickness of the top layer of 9 μm and an average pore size (from the scanning electron micrograph) of 28 nm. The scanning electron micrographs of membrane E2 are illustrated in FIGS. 1a, 1b and 1c. FIG. 1a shows the entire membrane cross-section, FIG. 1b a section of the foam structure above the caverns, FIG. 1c shows the membrane surface.

In FIG. 1a, a cross-section through the membrane E2 produced according to the invention is illustrated. A boundary layer delimiting the membrane is detectable (illustrated at the top in the micrograph), which has a continuous configuration. In the interior of the membrane, cavities which are produced during the precipitation step are detectable. FIG. 1b shows an enlarged section from FIG. 1a, the boundary layer sealing the membrane is hereby illustrated. It is detectable that no cavities are contained in this boundary layer. FIG. 1c shows a surface micrograph of membrane E2, i.e. a plan view on the boundary layer illustrated in FIG. 1a or 1b in cross-section. It is detectable that the surface of membrane E2 shows an extensively homogeneous distribution of the pores.

Membranes F to I from table 2 were left respectively for only 1 h in the precipitation bath, treated for 0.5 h in 95° C. hot water and dried moist for 2 h at 120° C. All of the membranes from table 2, E to I, show a smooth, glossy surface.

With the porometer, membranes F to I from table 2 were further characterised. The values are reported in table 3. The average pore size, in the case of the crosslinked membranes, is between 23 and 25 nm. The pore size at the bubble point is below 50 nm between 40-45 nm or at 27 nm for membrane F.

TABLE 3

| PS No. according | Membrane according | Pore size | Average pore |
|---|---|---|---|
| to table 5, 6 | to table 6 | BP, nm | size, nm |
| 5 | F | 27 | 23 |
| 6 | G | 40 | 24 |
| 7 | H | 45 | 25 |
| 7 | I | 44 | 24 |

In FIG. 2, the principle of the chemical reaction taking place during the crosslinking of polyacrylonitrile is illustrated. The reaction is explained with the example of a crosslinker with an amino group, such as for example PEI. A nucleophilic attack of the amino group on the cyano group of the acrylonitrile is thereby effected. In the presence of at least two amino groups in the crosslinker, linkage of different polymer chains of polyacrylonitrile can be effected in the illustrated manner.

Since the crosslinking reaction leads to products which produce an intensive signal in the IR, some crosslinked membranes were analysed with the FT-IR in the ATR mode. PAN shows, in the FT-IR, an intensive signal at 1454 cm⁻¹, in addition to the cyanide band at 2242 cm⁻¹. The crosslinker PEI shows only not very intensive signals at 1478 and 1565 cm⁻¹. Five membranes from table 2, crosslinked with PEI (E and F with respectively 10% PEI, G with 5% PEI and H with 3% PEI) and also a PAN membrane without crosslinker were investigated in the FT-IR. The FT-IR pictures are illustrated in FIG. 3. For comparability, the intensity was standardised to 1454 cm⁻¹. By means of the crosslinking, a new signal was produced at 1666 cm⁻¹ which can be assigned to the amidine bond. The intensity of the signal and hence the crosslinking is proportional to the quantity of PEI in the pouring solution. A further, important factor is the soaking time and the temperature during the membrane production. In the case of 3 h soaking at 22° C., the signal typical for the crosslinking is less intensive. Crosslinker PEI was therefore removed with the water by a fairly long washing time. The best crosslinking is obtained if, after precipitation of the membrane, the membrane remains in the precipitation bath for only 5 minutes to 30 minutes and is washed directly further under crosslinking conditions at 90-95° C.

### EXAMPLE 4

### Detection of Amino Groups of the Crosslinked Membrane

A piece of membrane with a surface area of 45.3 cm² from membrane F according to example 3, table 2, was cut into small pieces. The maximum quantity of PEI-P contained therein was calculated at 10 mg. Primary, secondary and tertiary amine was completely neutralised with 10 ml 0.1N HCl. The excess of HCl was titrated back with 0.1N NaOH. The quantity of available amine present in the membrane was calculated at 1.8 mg. This corresponds, after the membrane production including washing and crosslinking, to a quantity of approx. 18% of the amine used (PEI). This enables a further, chemical crosslinking of the membrane with known methods, such as bi- or multifunctional acids, isocyanates or the like.

In the following examples, the non-solvent 1,3-dioxolane was replaced in part by ethyl lactate, the commercially available 50% solution was used, instead of freeze-dried PEI-P, or the PEI-P was dried azeotropically. Furthermore, the polyethylene imine was modified with MIBK. As a result, a protective group which blocks the reactivity of the crosslinking is introduced. By means of the precipitation process in water and the temperature treatment, the protective group is cleaved again.

### EXAMPLE 5

### Pouring Solution Made of DMSO with the Additive Ethyl Lactate and PEI-P Made of 50% Aqueous Solution

A 9.4% solution in DMSO/ethyl lactate (84/16) was produced from PAN-2, which solution comprised 5% PEI-P, relative to the PAN-2. For this purpose, a 50% aqueous solution of PEI-P was diluted with ethyl lactate in order to achieve a PEI-P content of 10%. PAN-2 was dissolved in DMSO/ethyl lactate and the PEI-P solution was added in drops and agitated well at RT. The solution was pressure-filtered and degassed for 2 h at RT. The viscosity was 8.23 Pa*s. Membranes were drawn with the parameters: gap=200 μm, drawing rate=1 m/min. The membranes were washed in water for 1.5 h at 90° C. and dried in the drying cabinet with circulating air for 2 h at 105° C.

The bubble point was at 137+/−23 nm, the average pore size at 31+/−3.9 nm. At 3 bar, a nitrogen flow of 400-450 m³/m²*h*bar was measured. The viscosity of the closed pouring solution rose after 9 days to 9.1 Pa*s. Membranes were produced again according to the same parameters. After 9 days ageing of the pouring solution, the bubble point was approx. the same at 138+/−40 nm, the average pore size was reduced to 26.6+/−3.6 nm. The nitrogen flow measured at 3 bar was reduced insubstantially to 370-400 m³/m²*h*bar.

### EXAMPLE 6

### Pouring Solution Made of DMSO with the Additive Ethyl Lactate and 5% Azeotropically Dried PEI-P

Firstly, PEI-P was dried azeotropically with toluene as entrainer and produced in DMSO/ethyl lactate (84/16) as 10% solution. PAN-2 was dissolved in DMSO/ethyl lactate (84/16) and mixed with the solution of PEI-P at RT and agitated well. The concentration of PAN-2 was 9.4%; the content of PEI-P, relative to PAN-2, was at 5.1%. The solution was pressure filtered and degassed for 2 h at RT. The viscosity was 9.87 Pa*s. Membranes were drawn with the parameters: gap=200 μm, drawing rate=1 m/min. The membranes were washed in water for 1.5 h at 90° C. and dried in the drying cabinet with circulating air at 90° C.

The bubble point was at 28.3+/−0.5 nm, the average pore size at 23.1+/−0.7 nm. The nitrogen flow measured at 3 bar was at 230 m³/m²*h*bar. After one day ageing, membranes were drawn again with the same parameters. Treatment in water took place for 7 h at 90° C. and drying in air.

The bubble point was at 28.9+/−4.5 nm, the average pore size at 22.5+/−0.6 nm. The nitrogen flow measured at 3 bar was at 260 m³/m²*h*bar. The viscosity of the pouring solution was measured again after 16 days and a value of 10.0 Pa*s was found. Hence, the viscosity increased only insubstantially in 16 days dwell time, 9.87 to 10.0 Pa*s, and the reactive pouring solution is sufficiently stable to produce membranes with defined properties.

### EXAMPLE 7

### Pouring Solution Made of DMSO with the Additive Ethyl Lactate and 10% Azeotropically Dried PEI-P)

A pouring solution was produced as in example 6, the content of PEI-P being however doubled to 10%. The concentration of PAN-2 was at 9.4% and a viscosity of 9.52 Pa*s was measured. The viscosity was stable after three days ageing. After pressure filtration, it was left to stand for 1 day for degassing and membranes with the parameters according to example 6 were produced. The membranes were dried overnight in air. The bubble point was at 23 nm, the average pore size was determined at 20 nm. The nitrogen flow measured at 3 bar was at 200m³/m²*h*bar.

### EXAMPLE 8

### Production of PEI-Ketimine

A 50% solution of PEI-P in water was freeze-dried. 11.3 g of freeze-dried PEI-P was coated in a flask with water separator and cooler with 120 g methyl isobutyl ketone (MIBK) and heated overnight until reflux with magnetic agitation. The excess MIBK was withdrawn on the rotational evaporator and 26.7 g residue (PEI-ketimine) was obtained. The chemical reaction is illustrated in FIG. 4, when the reaction was taking place, the NH₂₊ terminus of the PEI reacts with the keto group of the ketone.

### EXAMPLE 9

### Pouring Solution Made of DMSO/1,3-Dioxolane and PEI-Ketimine 20%

From the PEI-ketimine of example 8, a 25% solution in 1,3-dioxolane was produced. PAN-2 was dissolved in DMSO/1,3-dioxolane (47/53) and added to a part of the PEI-ketimine solution and mixed well. The solution showed slight cloudiness. The content of PAN-2 was at 9.3%, in ratio to PAN-2, 20% PEI-MIBK was added. The pouring solution was pressure-filtered and degassed at RT by standing overnight. The viscosity of the solution was 10.3 Pa*s. Membranes with a gap of 200 μm and a drawing rate of 1 m/min were produced. The evaporation times in air were set to 0.5 min, 1 min and 3 min and the membranes were precipitated in water at RT. Washing took place for 2.5 h at 75° C. and a further 1.5 h at 90° C. and drying took place in air.

As a function of the evaporation time, the average pore size was reduced from 33.4 nm (0.5 min) to 30.9 nm (1 min) to 29.1 nm (3 min). The bubble point was at approx. 50 nm and did not change.

The nitrogen flow measured at 3 bar was at 300 m³/m²*h*bar (0.5 and 1 min evaporation time), after 3 min the flow was reduced to 250 m³/m²*h*bar. The membranes were temperature-treated and the stability in DMF, the best solvent for PAN, was measured. Membranes with 3 min evaporation time were heated with circulating air in the drying cabinet with a ramp of 1° C. from 40 to 125° C. and were left for 50 min at this temperature (T1). A part of the membranes was heated in addition from 125° C. with a ramp of 1° C. to 150° C. and was left for 50 min at this temperature (T2). A further membrane was heated with a ramp of 1° C. from 50° C. to 135° C. and kept for 2 h at this temperature (T3). Samples of the temperature-treated membranes T1, T2 and T3 were placed in DMF and rinsed with DMF/water 1+1 and pure water after 2 days at RT, washed off with ethanol and dried for 1 h at 85° C. The data are compiled in table 4. By the treatment in the solvent DMF, the average pore size and the nitrogen flow are reduced, the obtained membranes are not however destroyed.

TABLE 4

| Membrane | Bubble | Average pore | Nitrogen |
|---|---|---|---|
| No. | point, nm | size, nm | flow, m³/m²*h*bar |
| T1 | 54 | 28.8 | 121 |
| T1 DMF | 164 | 27.4 | 38 |
| T2 | 41 | 28.9 | 60 |
| T2 DMF | 39 | 23.5 | 40 |
| T3 | 66 | 32.0 | 200 |
| T3 DMF | 130 | 30.0 | 85 |

The degree of crosslinking was analysed by FT-IR, analogously to the explanations relating to example 3 and an intensive signal was found at 1666 cm⁻¹. The intensity increased due to the heat treatment in the drying cabinet.

### EXAMPLE 10

### Pouring Solution Made of DMSO/1,3-Dioxolane and PEI-Ketimine 10%

As in example 9, a pouring solution made of PAN-2 and PEI-ketimine in DMSO/1,3-dioxolane was produced. The concentration of PAN-2 was 8.9%, the content of PEI-MIBK was at 10%, relative to PAN-2. The viscosity of the pouring solution was at 7.29 Pa*s. Membranes were produced according to the parameters in example 9, the evaporation time was 2 min before the membranes were precipitated in water at RT. The membranes were washed at 75° C. for 0.5 h and at 90° C. for 1 h and dried overnight in air.

The bubble point of the air-dried membranes was at 30 nm, the average pore size at 19 nm. The nitrogen flow was determined at 200 m³/m²*h*bar.

The membranes were treated for 1 h at 120° C. with circulating air in the drying cabinet and the data were measured with the porometer. The bubble point was increased due to the temperature treatment to 60+/−10 nm, the average pore size to 20.8+/−1.9 nm. After the temperature treatment, the nitrogen flow was at 270 m³/m²*h*bar.

1-22. (canceled)

23. A method for the production of a solvent-stable polymer membrane in which a solution comprising
a) poly(meth)acrylonitrile, a copolymer based on (meth)acrylonitrile or mixtures thereof,
b) at least one crosslinker for poly(meth)acrylonitrile or a copolymer based on (meth)acrylonitrile, and
c) at least one solvent for poly(meth)acrylonitrile or a copolymer based on (meth)acrylonitrile in which the previously mentioned components are present in dissolved state
is poured as a film or spun to form a hollow thread,
the poly(meth)acrylonitrile, copolymer based on (meth)acrylonitrile or mixture thereof is precipitated by a phase-inversion process,
and the poly(meth)acrylonitrile, copolymer based on (meth)acrylonitrile or mixture thereof is crosslinked by heat treatment at temperatures increased relative to room temperature.

24. The method according to claim 23, wherein the film is poured onto a substrate.

25. The method according to claim 23, wherein, after the phase-inversion process, the obtained film or hollow thread is washed with water.

26. The method according to claim 23, wherein the heat treatment is effected at a temperature of 50 to 150° C.

27. The method according to claim 23, wherein, after crosslinking and/or washing, drying of the membrane is implemented.

28. A polymer membrane produced according to the method of claim 23, which includes a continuously configured crosslinking of the poly(meth)acrylonitrile or of the copolymer based on (meth)acrylonitrile.

29. The polymer membrane according to claim 28, which is in the form of a flat membrane or hollow thread membrane.

30. The polymer membrane according to claim 28, wherein the thickness of the membrane is 20 to 200 μm.

31. The polymer membrane according to claim 28, which has a pore size of the membrane at the bubble point of 20 to 100 nm.

32. The polymer membrane according to claim 28, which has an average pore size of 15 to 30 nm.

33. The polymer membrane according to claim 28, which has a nitrogen permeability J_{N2} of 10 to 1,000 m³/(m²*h*bar).

34. The polymer membrane according to claim 28, which has a foam structure.

35. A solution for the production of a polymer membrane, comprising
a) poly(meth)acrylonitrile, a copolymer based on (meth)acrylonitrile or mixtures thereof,
b) at least one crosslinker for poly(meth)acrylonitrile or a copolymer based on (meth)acrylonitrile, and
c) at least one solvent for poly(meth)acrylonitrile or a copolymer based on (meth)acrylonitrile, in which the previously mentioned components are present in dissolved state.

36. The solution according to claim 35, wherein the solvent is selected from the group consisting of dimethylsulphoxide (DMSO), dimethylformamide (DMF), N-methylpyrrolidone (NMP), dimethylacetamide (DMAC), tetrahydrothiophene-1,1-dioxide (sulpholane), aqueous solution of sodium thiocyanate, and aqueous solution of zinc chloride, and mixtures thereof.

37. The solution according to claim 35, wherein the crosslinker
a) is an amino group-containing polymer, or
b) is one that is released in situ.

38. The solution according to claim 37, wherein the crosslinker released in situ is selected from blocked polyethylene imine, blocked polyvinyl amine, blocked polyallyl amine, and mixtures and combinations thereof.

39. The solution according to claim 38, wherein the blocked polyethylene imine is a ketimine of polyethylene imine, the blocked polyvinyl amine is a ketimine of polyvinyl amine, and the blocked polyallyl amine is a ketimine of polyallyl amine.

40. The solution according to claim 35, which further contains a non-solvent in which poly(meth)acrylonitrile or the copolymer based on (meth)acrylonitrile does not dissolve and which is miscible with the solvent.

41. The solution according to claim 35, wherein the total content of poly(meth)acrylonitrile, of the copolymer based on (meth)acrylonitrile or mixtures thereof, relative to the solvent is from 1 to 30% by weight.

42. The solution according to claim 35, wherein the total content of the crosslinker, relative to poly(meth)acrylonitrile, the copolymer based on (meth)acrylonitrile or mixtures thereof, is from 1 to 50% by weight.

43. The solution according to claim 40, wherein the content of non-solvent, relative to the content of the solvent or of the mixture of at least two solvents, is from 50 to 60% by weight.

44. The solution according to claim 35, wherein the copolymer based on (meth)acrylonitrile is obtained by copolymerisation of (meth)acrylonitrile with at least one comonomer selected from the group consisting of (meth)allyl sulphonic acid and salts thereof.

45. The solution according to claim 35, which a viscosity of 1.5 to 20 Pa·s.
